(19) United States
(12) Patent Application Publication
(10) Pub. No.: US 2026/0341184 A1
(43) Pub. Date: Oct. 29, 2026

(54) VOLTAGE SETTING METHOD OF DISPLAY DEVICE AND VOLTAGE SETTING DEVICE

(71) Applicant: SAMSUNG DISPLAY CO., LTD., YONGIN-SI (KR)

(72) Inventor: Si Beak PYO, Yongin-si (KR)

(21) Appl. No.: 19/393,678

(22) Filed: Nov. 19, 2025

(30) Foreign Application Priority Data
Apr. 29, 2025 (KR) 10-2025-0056603

(51) Int. Cl. G09G 3/00; G09G 3/3233

(52) U.S. Cl. CPC G09G 3/006; G09G 3/3233; G09G 2300/0819; G09G 2300/0842; G09G 2300/0861; G09G 2320/0257

(57) ABSTRACT

A voltage setting method of a display device including pixels emitting a first color in a first data voltage range, pixels emitting a second color in a second data voltage range, and pixels emitting a third color in a third data voltage range. The voltage setting method includes setting an initialization voltage commonly applied to gate electrodes of driving transistors included in the pixels. The setting the initialization voltage includes selecting lowest minimum data voltage of minimum data voltages of the first to third data voltage ranges as a fixed test data voltage, and varying test data voltages and test initialization voltages of pixels of remaining colors other than a color corresponding to the fixed test data voltage to find a final test initialization voltage corresponding to a target luminance and a target color coordinate, and setting the final test initialization voltage as the initialization voltage.

### CROSS-REFERENCE TO RELATED APPLICATIONS

This application claims priority under 35 U.S.C. § 119 to and benefits from Korean Patent Application No. 10-2025-0056603 filed on Apr. 29, 2025 in the Korean Intellectual Property Office., the entire contents of which is herein incorporated by reference.

### TECHNICAL FIELD

The disclosure relates to an electronic device that includes a display device that includes a voltage setting device and a method of setting a voltage.

### DISCUSSION OF THE RELATED ART

As information technology has evolved, the display device that serves as a connection medium between users and information has grown in significance. As a result, display technologies such as liquid crystal display devices and organic light emitting display devices have become more vital in everyday life.

To reduce manufacturing costs, multiple display devices may be simultaneously produced on a mother glass having a large area, and these display devices can then be separated into individual display devices by scribing.

However, for a case in which the display devices are produced simultaneously on a mother substrate and then scribed, the resultant individual display devices may have different driving characteristics, either due to their differing location on the mother glass or for other reasons. Therefore, if voltages of a same magnitude are applied to each of the individual display devices yielded from a single mother glass, differing luminance may result.

### SUMMARY

A voltage setting method of a display device according to an embodiment of the disclosure is provided. The display device includes a plurality of pixels including a plurality of first pixels emitting a first color in a first data voltage range, a plurality of second pixels emitting a second color in a second data voltage range, and a plurality of third pixels emitting a third color in a third data voltage range. The method includes setting an initialization voltage commonly applied to gate electrodes of driving transistors included in the pixels. The setting of the initialization voltage includes selecting lowest minimum data voltage of minimum data voltages of the first to third data voltage ranges as a fixed test data voltage, varying test data voltages and test initialization voltages of ones of the plurality of pixels of remaining colors other than a color corresponding to the fixed test data voltage to find a final test initialization voltage corresponding to a target luminance and a target color coordinate, and setting the final test initialization voltage as the initialization voltage.

According to an embodiment, the voltage setting method may further include setting data voltages of the plurality of pixels. The data voltages may be set to be greater than or substantially equal to test data voltages corresponding to the target luminance, the target color coordinate, and the final test initialization voltage.

According to an embodiment, the setting of the final test initialization voltage as the initialization voltage may include varying the test initialization voltage and the test data voltages of ones of the plurality of pixels of the remaining colors to search voltage sets corresponding to the target luminance and the target color coordinate, and setting a test initialization voltage of a voltage set having largest test initialization voltage among the voltage sets searched as the final test initialization voltage.

According to an embodiment, the setting of the final test initialization voltage as the initialization voltage may include setting an initial test initialization voltage, and varying test data voltages of ones of the plurality of pixels of the remaining colors; checking whether current luminance and current color coordinate fall in a target range, and performing the varying of the test data voltages of the pixels of the remaining colors again if the current luminance and the current color coordinate do not fall in the target range.

According to an embodiment, the setting of the final test initialization voltage as the initialization voltage may further include checking whether test data voltages of ones of the plurality of pixels of the remaining colors fall in corresponding data voltage ranges if the current luminance and the current color coordinate fall in the target range, and setting a current test initialization voltage as the final test initialization voltage if the test data voltages of plurality of pixels of the remaining colors fall in corresponding data voltage ranges.

According to an embodiment, the setting of the final test initialization voltage as the initialization voltage may further include decreasing the current test initialization voltage if the test data voltages of ones of the plurality of pixels of the remaining colors do not fall in corresponding data voltage ranges.

According to an embodiment, the setting of the final test initialization voltage as the initialization voltage may further include checking if the current test initialization voltage is greater than minimum initialization voltage, performing the varying the test data voltages of pixels of the remaining colors again if the current test initialization voltage is greater than the minimum initialization voltage.

According to an embodiment, the setting of the final test initialization voltage as the initialization voltage may further include determining the display device to be defective if the current test initialization voltage is less than the minimum initialization voltage.

A voltage setting method of a display device according to an embodiment of the disclosure is provided. The display device including a plurality of pixels including a plurality of first pixels emitting a first color in a first data voltage range, a plurality of second pixels emitting a second color in a second data voltage range, and a plurality of third pixels emitting a third color in a third data voltage range. The voltage setting method includes setting an initialization voltage commonly applied to gate electrodes of driving transistors included in the pixels. The setting of the initialization voltage includes setting an initial test initialization voltage, varying test data voltages of the plurality of pixels and the initial test initialization voltage to find a final test initialization voltage corresponding to a target luminance and a target color coordinate, and setting the final test initialization voltage as the initialization voltage. The final test initialization voltage may be less than or substantially equal to the initial test initialization voltage.

According to an embodiment, the setting of the final test initialization voltage as the initialization voltage may include varying test data voltages of the pixels, checking whether the current luminance and the current color coordinate fall in a target range, and performing the varying the test data voltages again if the current luminance and the current color coordinate do not fall in the target range.

According to an embodiment, the setting of the final test initialization voltage as the initialization voltage may further include checking whether test data voltages of the pixels fall in corresponding data voltage ranges if the current luminance and the current color coordinate fall in the target range; and setting a current test initialization voltage as the final test initialization voltage if the test data voltages fall in the corresponding data voltage ranges.

According to an embodiment, the setting of the final test initialization voltage as the initialization voltage may further include decreasing the current test initialization voltage if the test data voltages do not fall in corresponding data voltage ranges.

According to an embodiment, the setting of the final test initialization voltage as the initialization voltage may further include checking whether the current test initialization voltage is greater than a minimum initialization voltage and performing the varying the test data voltages again if the current test initialization voltage is greater than the minimum initialization voltage.

According to an embodiment, the setting of the final test initialization voltage as the initialization voltage may further include determining the display device to be defective if the current test initialization voltage is less than the minimum initialization voltage.

An electronic device that includes a display device that includes a voltage setting device for setting a voltage of the display device according to an embodiment is provided. The display device includes a plurality of pixels including a plurality of first pixels emitting a first color in a first data voltage range, a plurality of second pixels emitting a second color in a second data voltage range, and a plurality of third pixels emitting a third color in a third data voltage range. The voltage setting device includes a test control unit configured to provide test voltages to the display device to enable the display device to display an image, and an optical system configured to measure luminance and color coordinate of the image. The test voltages include a test initialization voltage and test data voltages. The initialization voltage is a voltage commonly applied to gate electrodes of driving transistors included in the pixels. The test control unit is further configured to select lowest minimum data voltage of minimum data voltages of the first to third data voltage ranges as a fixed test data voltage. The test control unit is further configured to vary the test initialization voltage and the test data voltages of pixels of remaining colors other than a color corresponding to the fixed test data voltages to find a final test initialization voltage corresponding to a target luminance and a target color coordinate, and set the final test initialization voltage as the initialization voltage.

According to an embodiment, the test control unit is further configured to set the data voltages of the pixels. The data voltages may be set to be greater than or substantially equal to test data voltages corresponding to the target luminance, the target color coordinate, and the final test initialization voltage.

According to an embodiment, the test control unit may be further configured to search voltage sets corresponding to the target luminance and the target color coordinate by varying the test initialization voltage and the test data voltages of plurality of pixels of the remaining colors. The test control unit may be further configured to set a test initialization voltage of a voltage set having largest test initialization voltage among the voltage sets searched as the final test initialization voltage.

According to an embodiment, the test control unit may be further configured to set an initial test initialization voltage and varies test data voltages of pixels of the remaining colors. The test control unit may be further configured to check whether the current luminance and the current color coordinate fall in a target range. The test control unit may be further configured to vary test data voltages of the plurality of pixels of the remaining colors again if the current luminance and the current color coordinate do not fall in the target range.

According to an embodiment, the test control unit may be further configured to check whether the current luminance and the current color coordinate fall in the target range, test data voltages of pixels of the remaining colors fall in corresponding data voltage ranges. The test control unit may be further configured to set a current test initialization voltage as the final test initialization voltage if the test data voltages of pixels of the remaining colors fall in corresponding data voltage ranges.

According to an embodiment, the test control unit may be further configured to decrease the current test initialization voltage if the test data voltages of pixels of the remaining colors do not fall in corresponding data voltage ranges.

### BRIEF DESCRIPTION OF THE DRAWINGS

The above and other features of the disclosure will become more apparent by describing in further detail exemplary embodiments thereof with reference to the accompanying drawings, in which:

FIG. 1 is a drawing illustrating a display device according to an embodiment of the disclosure.

FIG. 2 is a drawing illustrating a pixel according to an embodiment of the disclosure.

FIGS. 3 and 4 are drawings illustrating changing display frequency according to an embodiment of the disclosure.

FIG. 5 is a drawing for illustrating an address scan period according to an embodiment of the disclosure.

FIG. 6 is a drawing for illustrating a self scan period according to an embodiment of the disclosure.

FIG. 7 is a drawing for illustrating a voltage setting device according to an embodiment of the disclosure.

FIG. 8 is a drawing for illustrating a voltage setting method of a display device according to an embodiment of the disclosure.

FIG. 9 is a drawing for illustrating a step of setting an initialization voltage according to an embodiment of the disclosure.

FIG. 10 is a drawing for illustrating a step for setting an initialization voltage according to an embodiment of the disclosure.

FIG. 11 is a drawing for illustrating a step for setting an initialization voltage according to an embodiment of the disclosure.

FIG. 12 is a block diagram of an electronic device according to an embodiment.

FIGS. 13-15 are schematic diagrams of electronic devices according to various embodiments.

### DETAILED DESCRIPTION OF THE EMBODIMENTS

Hereinafter, with reference to the accompanying drawings, various embodiments of the disclosure are described in detail so as to facilitate practice by one having ordinary skill in the art to which the disclosure belongs. The disclosure may be implemented in many different forms and is not limited to the embodiments described herein.

To clearly illustrate the disclosure, parts not pertinent to the description have been omitted, and identical or similar components are designated by the same reference numerals throughout the specification. Accordingly, the aforementioned reference numerals may be used in other drawings.

While each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

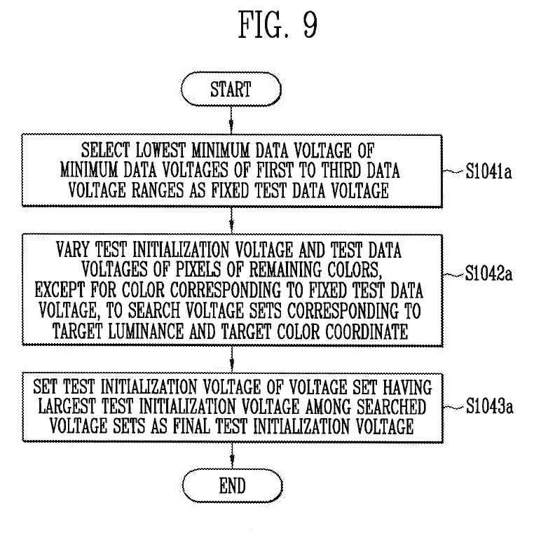

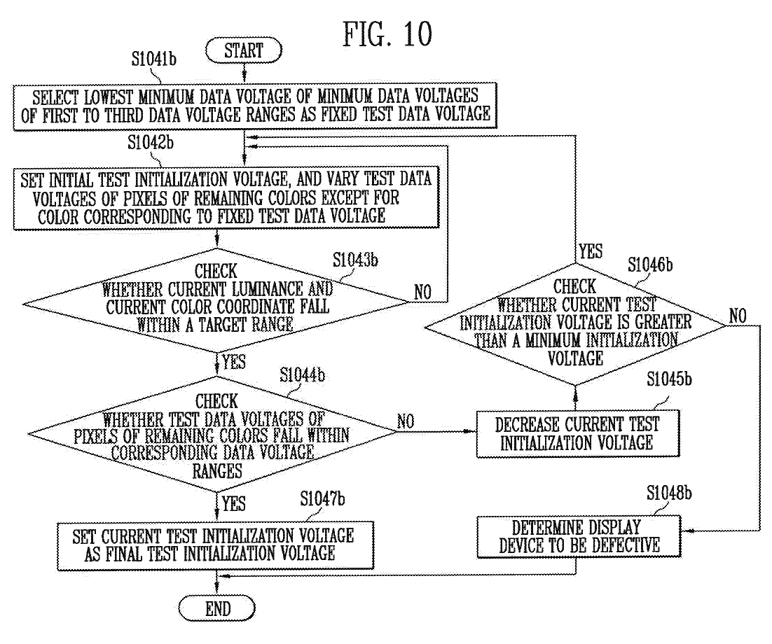

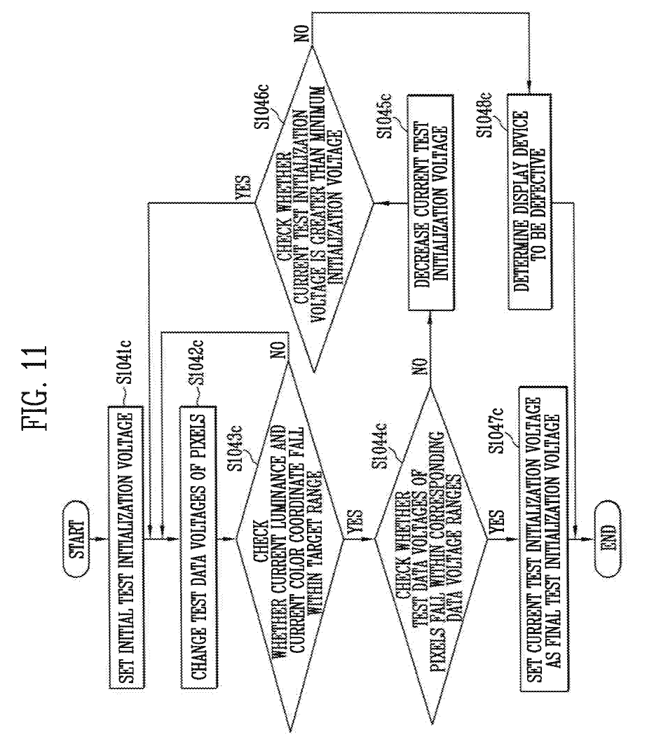

According to an embodiment of the disclosure, there is provided a voltage setting device, and a voltage setting method that sets (or determines) an initialization voltage in a display device by applying voltage sets (or combinations of test data voltages and test initialization voltages) to pixels and checking whether a resulting luminance and a resulting color coordinate displayed by the pixels in the display device falls in a target range. A goal is to set the initialization voltage as high as possible for the target ranges of color coordinates and luminance to reduce afterimage. In some embodiments of FIGS. 10 and 11, another goal is to also ensure that the test data voltages used are in data voltage ranges. Another variation is to vary data voltages of only two out of three colors displayed on the display device as in the embodiments of FIGS. 9 and 10.

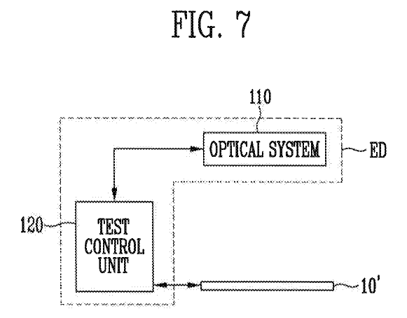

The voltage setting device ED of FIG. 7 may include an optical system 110 and a test control unit 120. The test control unit 120 may apply the voltage sets to the pixels of the display device during the testing method, and the optical system 110 acquires the image displayed on the display device along with the luminance and color coordinates of the image and provides the same to the test control unit 120. Embodiments of the disclosure seek to set an initialization voltage that not only achieves a luminance and color coordinate in a target range, but also where the initialization voltage is as high as possible to reduce afterimages.

When the term "identical" is used in the description, it is intended to mean "substantially identical," i.e., identical to the extent that a person of ordinary skill in the art would be satisfied that they are identical. Other expressions may also omit "substantially".

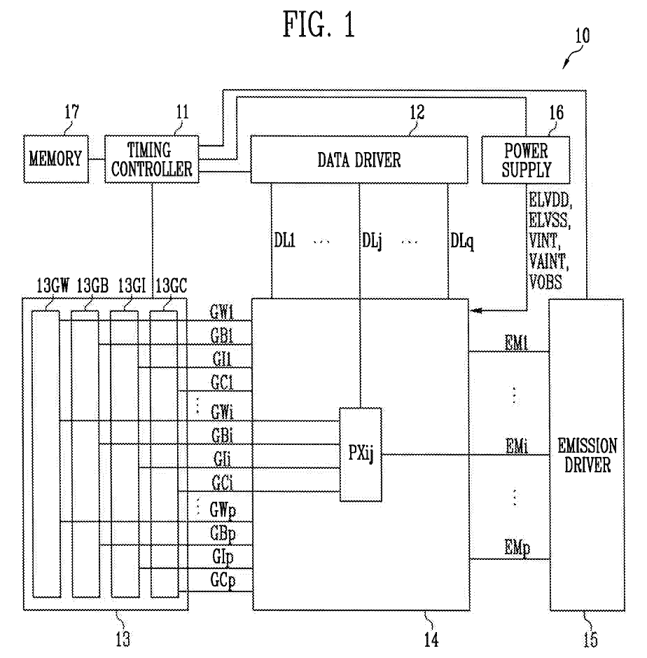

FIG. 1 is a drawing illustrating a display device according to an embodiment of the disclosure.

Referring to FIG. 1, a display device 10 according to an embodiment of the disclosure may include a timing controller 11, a data driver 12, a scan driver 13, a pixel unit 14, an emission driver 15, a power supply 16, and a memory 17.

The timing controller 11 may receive grayscales for the input image (or, input frame). The grayscales may include a first color grayscale, a second color grayscale, and a third color grayscale. The first color grayscale may be a grayscale for representing a first color, the second color grayscale may be a grayscale for representing a second color, and the third color grayscale may be a grayscale for representing a third color.

Further, the timing controller 11 may receive control signals for the image. These control signals may include a horizontal synchronization signal (Hsync), a vertical synchronization signal (Vsync), and a data enable signal. The vertical synchronization signal may include multiple pulses, each of which indicates the end of a previous frame period and the beginning of a current frame period based on when the pulse occurs. The interval between adjacent pulses of the vertical synchronization signal may correspond to a frame period. The horizontal synchronization signal may include multiple pulses, each indicating the end of a previous horizontal period and the beginning of a new horizontal period based on when the pulses occur. The interval between adjacent pulses of the horizontal synchronization signal may correspond to a horizontal period. The data enable signal may have an enable level for certain horizontal periods and a disabled level for the rest of the period. When the data enable signal is at the enable level, it may indicate that color grayscales are supplied in those horizontal periods.

The timing controller 11 may provide grayscales rendered or calibrated to meet the specifications of the display device 10 to the data driver 12. Further, the timing controller 11 may provide clock signals, scan start signals, and the like to the scan driver 13. The timing controller 11 may provide a clock signal, an emission stop signal, and the like to the emission driver 15.

The data driver 12 may generate data voltages provided to the data lines DL1, ..., DLj, ..., DLq by utilizing the control signals and the grayscales received from the timing controller 11, where q may be an integer greater than 2, and j may be an integer greater than 1 that is less than q. The data driver 12 may sample the grayscales using a clock signal and apply the data voltages corresponding to the grayscales to the data lines in a unit of a pixel row.

The magnitudes of the data voltages may vary depending on the corresponding grayscale. The data voltages may include a black data voltage. The black data voltage may be a data voltage that should be written to a pixel when the pixel displays a black image. For example, the black data voltage may correspond to a minimum grayscale (e.g., zero grayscale).

The magnitude of the data voltages may vary depending on the maximum luminance of the display device 10. The maximum luminance may be a luminance of light emitted by the pixels set to a maximum grayscale (e.g., grayscale 255 when the grayscales are represented by 8 bits). For example, the maximum luminance may be a luminance of white light generated by the pixels of the pixel unit 14 emitting to correspond to a white grayscale. The unit of the luminance may be Nits. The maximum luminance may be named as a Display Brightness Value. Such maximum luminance may be set manually by a user's operation for the display device 10, or may be set automatically by an algorithm associated with an illumination sensor or the like. For example, the maximum value of the maximum luminance may be 2175 Nits, and the minimum value may be 4 Nits. The maximum and minimum values of the maximum luminance may vary depending on the product. Even for the same grayscale, different maximum luminance will result in different data voltages, which will result in different luminance of the pixels.

The scan driver 13 may include first to fourth scan drivers 13GW, 13GB, 13GI, 13GC. The first scan driver 13GW may provide first scan signals to the first scan lines GW1, ..., GWi, ..., GWp where p may be an integer greater than 2, and i may be an integer greater than 1 and less than p. The second scan driver 13GB may provide the second scan signals to the second scan lines GB1, ..., GBi, ..., GBp. The third scan driver 13GI may provide the third scan signals to the third scan lines GI1, ..., GIi, ..., GIp. The fourth scan driver 13GC may provide the fourth scan signals to the fourth scan lines GC1, ..., GCi, ..., GCp.

For example, the first scan driver 13GW may receive at least one scan clock signal and a scan start signal from the timing controller 11 to generate first scan signals to be provided to the first scan lines GW1 to GWp. The first scan driver 13GW may provide the first scan signals having pulses of the turn-on level to the first scan lines GW1 to GWp sequentially. For example, the first scan driver 13GW may be configured in the form of a shift register, and may generate the first scan signals by sequentially delivering a scan start signal in the form of a pulse of the turn-on level to the next scan stage under control of the scan clock signal.

Each of the second scan driver 13GB, the third scan driver 13GI, and the fourth scan driver 13GC may be configured similarly to the first scan driver 13GW, and therefore, redundant description is omitted. In accordance with embodiments, at least some of the first to fourth scan drivers 13GW, 13GB, 13GI, and 13GC may be a single, uninterrupted structure (or integrated). For example, two or more scan drivers may be a single, uninterrupted structure if the polarity and width of the pulses are the same. For example, referring now to FIG. 5, the third scan driver 13GI and the fourth scan driver 13GC may be a single, uninterrupted structure because the polarity and width of the pulses of the turn-on level applied to the third scan line GIi at time t2a and the pulses of the turn-on level applied to the fourth scan line GCi at time t3a are the same.

The emission driver 15 may generate emission signals to be provided to the emission lines EM1, ..., EMi, ..., EMp by receiving at least one emission clock signal and an emission stop signal from the timing controller 11. The emission driver 15 may provide the emission signals having pulses of the turn-off level sequentially to the emission lines EM1 through EMp. For example, the emission driver 15 may be configured in the form of a shift register, and may generate the emission signals by sequentially delivering the emission stop signals in the form of pulses of the turn-off level to the next emission stage under the control of the emission clock signal.

In FIG. 1, the first scan lines GW1 to GWp, the second scan lines GB1 to GBp, the third scan lines GI1 to GIp, the fourth scan lines GC1 to GCp, and the emission lines EM1 to EMp are shown as p number each. However, in other embodiments, at least one of the second scan lines GB1 to GBp, the third scan lines GI1 to GIp, the fourth scan lines GC1 to GCp, and the emission lines EM1 to EMp may be configured p/2 number or fewer. For example, two neighboring pixel rows may share a second scan line. Similarly, two neighboring pixel rows may share a third scan line, fourth scan line, or emission line. A pixel row refers to pixels connected to the same first scan line.

The pixel unit 14 may include pixels. Each pixel PXij may be connected to a corresponding data line DLj, scan lines GWi, GBi, GIi, GCi, and an emission line EMi. Each pixel PXij may include a light emitting element that emits based on a received data voltage.

The pixel unit 14 may include first pixels emitting light of a first color, second pixels emitting light of a second color, and third pixels emitting light of a third color. The first color, the second color, and the third color may be different colors. For example, the first color may be any one of red, green, and blue, the second color may be any one of red, green, and blue that is not the first color, and the third color may be any remaining color that is not the first and second colors among red, green, and blue. In addition, magenta, cyan, and yellow may be used in place of red, green, and blue as the first through third colors. For simplicity of explanation, the following assumes that the first color is red, the second color is green, and the third color is blue.

The pixels 14 may be arranged in various shapes, such as diamond PENTILE^{TM}, RGB-Stripe, S-stripe, Real RGB, normal PENTILE^{TM}, etc.

The power supply 16 may provide a voltage commonly provided to the pixels of the pixel unit 14. For example, the power supply 16 may provide a first power supply voltage ELVSS, a second power supply voltage ELVDD, an initialization voltage VINT, an anode initialization voltage VAINT, and a bias voltage VOBS. For example, the power supply 16 may be a power management integrated circuit (PMIC). For example, the power supply 16 may include multiple DC-DC converters.

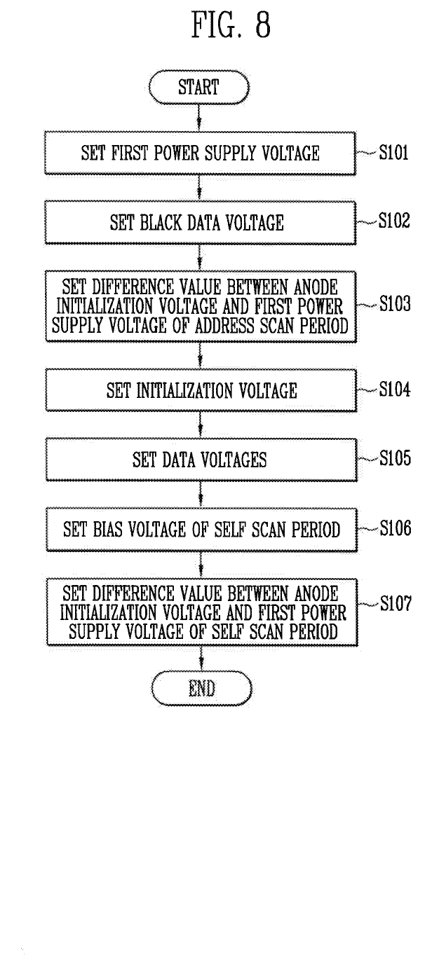

The memory 17 may store voltage values set for at least some of the voltages ELVSS, ELVDD, VINT, VAINT, VOBS, .... A method of setting the voltage values stored in the memory 17 will be described in more detail with reference to FIGS. 8-11. For example, the timing controller 11 may adjust the magnitude of the voltages ELVDD, ELVSS, VINT, VAINT, VOBS, ... provided from the power supply 16 and the data voltages provided from the data driver 12 by referring to the voltage values in the memory.

According to embodiments, the timing controller 11 and the data driver 12 may be configured as an (e.g., a single) integrated circuit. Further, the timing controller 11, the data driver 12, and the power supply 16 may be configured as an (e.g., a single) integrated circuit. Further, at least some of the timing controller 11, the data driver 12, the power supply 16, the scan driver 13, the emission driver 15, and the memory 17 may be configured as an (e.g., a single) integrated circuit. The configuration of each of these components, either integrally or separately, may be determined in various ways depending on the product.

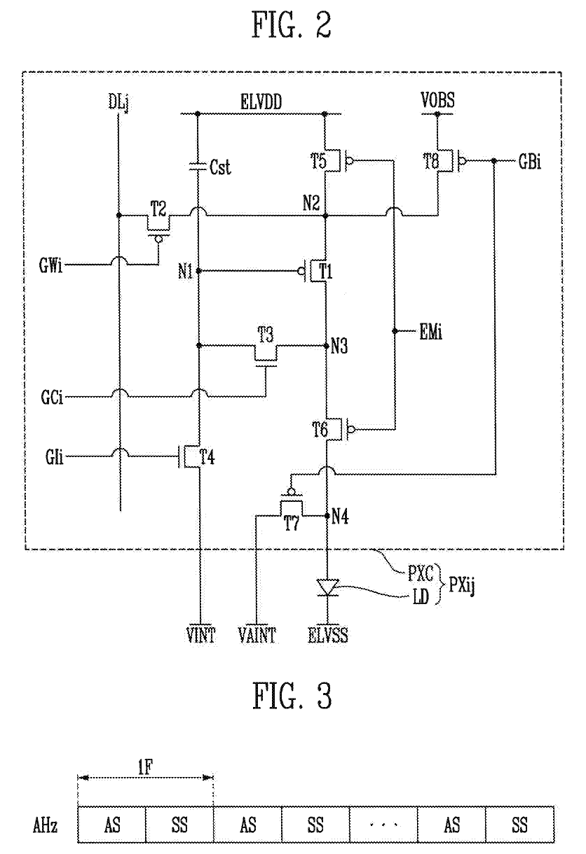

FIG. 2 is a drawing to illustrate a pixel according to an embodiment of the disclosure.

Referring to FIG. 2, a pixel PXij may include a pixel circuit PXC and a light emitting element LD. The pixel circuit PXC includes transistors T1, T2, T3, T4, T5, T6, T7, T8, and a storage capacitor Cst.

The pixel PXij may be located in the i-th pixel row, and may be located in the j-th pixel column. The pixel PXij may be a first pixel for representing the first color, a second pixel for expressing the second color or a third pixel for expressing the third color.

The P-type transistors may be polysilicon semiconductor transistors. A channel of an active layer of a polysilicon semiconductor transistor may include a polysilicon semiconductor. For example, the polysilicon semiconductor transistor may be a low temperature poly-silicon (LTPS) thin film transistor. Polysilicon semiconductor transistors have high electron mobility, and thus fast driving characteristics.

The N-type transistors may be oxide semiconductor transistors. A channel of an active layer of an oxide semiconductor transistor may include an oxide semiconductor. For example, the oxide transistor may be a low temperature polycrystalline oxide (LTPO) thin film transistor. Oxide semiconductor transistors have lower charge mobility compared to polysilicon semiconductor transistors. Therefore, the oxide semiconductor transistors may have a smaller amount of leakage current in the turn-off state compared to polysilicon semiconductor transistors.

The first transistor T1 may have a gate electrode connected to a first node N1, a first electrode connected to a second node N2, and a second electrode connected to a third node N3. The first transistor T1 may be a driving transistor. The first transistor T1 may be a P-type transistor.

The second transistor T2 may have a gate electrode connected to the first scan line GWi, a first electrode connected to the data line DLj, and a second electrode connected to the second node N2. The second transistor T2 may be a switching transistor. The second transistor T2 may be a P-type transistor.

The first scan driver 13GW may provide a first scan signal of the turn-on level that determines when the pixel PXij receives the data voltage. For example, in response to receiving the first scan signal of the turn-on level, the second transistor T2 may be turned on, and the second transistor T2 may apply the data voltage applied to the data line DLj to the second node N2.

The third transistor T3 may have a gate electrode connected to the fourth scan line GCi, a first electrode connected to the first node N1, and a second electrode connected to the third node N3. The third transistor T3 may be a diode-connecting transistor. The third transistor T3 may be an N-type transistor.

The fourth transistor T4 may have a gate electrode connected to the third scan line GIi, a first electrode connected to the first node N1, and a second electrode receiving an initialization voltage VINT. The fourth transistor T4 may be a gate initialization transistor. The fourth transistor T4 may be an N-type transistor.

The fifth transistor T5 may have a gate electrode connected to the emission line EMi, a first electrode receiving a second power supply voltage ELVDD, and a second electrode connected to the second node N2. The fifth transistor T5 may be a first emission control transistor. The fifth transistor T5 may be a P-type transistor.

The sixth transistor T6 may have a gate electrode connected to the emission line EMi, a first electrode connected to the third node N3, and a second electrode connected to the fourth node N4. The sixth transistor T6 may be a second emission control transistor. The sixth transistor T6 may be a P-type transistor.

The seventh transistor T7 may have a gate electrode connected to the second scan line GBi, a first electrode receiving an anode initialization voltage VAINT, and a second electrode connected to the fourth node N4. The seventh transistor T7 may be an anode initialization transistor. The seventh transistor T7 may be a P-type transistor. The magnitude of the anode initialization voltage VAINT may be different from the magnitude of the initialization voltage VINT.

The anode initialization voltage VAINT may be set differently depending on the type of light-emitting element LD. The emission start time may differ depending on the type of light-emitting element LD, and the difference in the emission start time may cause a color dragging phenomenon. For example, the magnitudes of the anode initialization voltage VAINT for the light-emitting element LD of the first color, the anode initialization voltage VAINT for the light-emitting element LD of the second color, and the anode initialization voltage VAINT for the light-emitting element LD of the third color may be set differently. In an embodiment, the anode initialization voltages VAINT for two colors of light-emitting elements LD may be set to be the same, and the anode initialization voltages VAINT for the remaining one color of light-emitting elements LD may be set to be different. In an embodiment, the anode initialization voltages VAINT for all light emitting elements LD may be set to be the same. This allows the difference in the emission timing of the light emitting elements LD for each color to be adjusted to prevent color dragging phenomenon.

The initialization voltage VINT may be set common to the pixels of the first, second, and third colors, i.e., the initialization voltage VINT may be applied at the same voltage level to the gate electrodes of the driving transistors included in the pixels of all colors.

The second scan driver 13GB may provide a second scan signal of the turn-on level that determines a timing for initializing the anode voltage of the light emitting element LD. For example, in response to receiving the second scan signal of the turn-on level, the seventh transistor T7 may be turned on, and the anode initialization voltage VAINT may be applied to the anode of the light-emitting element LD, such that the anode voltage of the light-emitting element LD is initialized to the anode initialization voltage VAINT.

The eighth transistor T8 may have a gate electrode connected to the second scan line GBi, a first electrode receiving a bias voltage VOBS, and a second electrode connected to the second node N2. The eighth transistor T8 may be a bias transistor. The eighth transistor T8 may be a P-type transistor.

The storage capacitor Cst may have a first electrode receiving a second power supply voltage ELVDD, and a second electrode may be connected to the first node N1.

An anode of the light emitting element LD may be connected to the fourth node N4, and a cathode of the light emitting element LD may receive the first power supply voltage ELVSS. The light emitting element LD may emit one of a first color, a second color, and a third color. The light emitting element LD may be a light emitting diode. The light emitting device LD may include an organic light emitting diode, an inorganic light emitting diode, a quantum dot/well light emitting diode, or the like. In the embodiment, a light emitting element LD is provided in each pixel, but in other embodiments, multiple light emitting elements may be provided in each pixel. The light emitting elements may be connected in series, parallel, series-parallel, or the like.

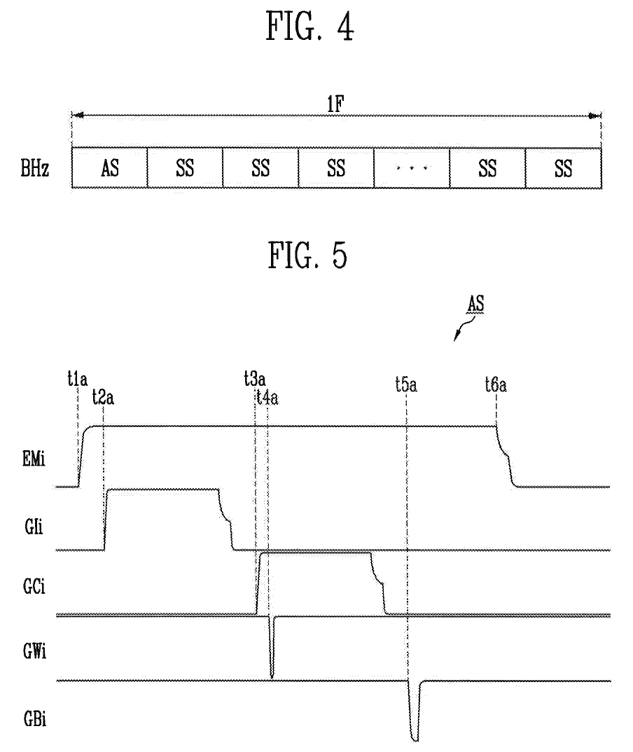

FIGS. 3 and 4 are drawings to illustrate changing the display frequency according to an embodiment of the disclosure.

The display device 10 may support a variable refresh rate (VRR). The refresh rate is the frequency at which a data voltage is written to the pixel PXij, which may also be referred to as a screen scan rate, a screen play rate, and may represent the number of image frames played in a second.

For example, the pixel unit 14 may display an image at a first frequency AHz in a first mode (see FIG. 3), and may display an image at a second frequency BHz that is smaller than the first frequency AHz in a second mode (see FIG. 4).

For example, in the first mode, each frame period 1F may include for each pixel PXij, an (e.g., single) address scan period AS and a (e.g., single) self scan period SS. For example, in the second mode, each frame period 1F may include for each pixel PXij, an (e.g., single) address scan period AS and multiple self scan periods SS. As the second frequency BHz is smaller, the number of self scan periods SS included in a (e.g., single) frame period 1F may increase. In another example, in the third mode, each frame period 1F may include for each pixel PXij, an address scan period AS and no self scan period SS.

The address scan period AS is the period during which the data voltage is written to the pixel PXij. The address scan period AS may also be named the data programming period, which receives data voltage from the data line DLj.

The self scan period SS is a period during which no data voltage is written to the pixel PXij. During the emission period of the self scan period SS, the pixel PXij may emit light using the data voltage written in the address scan period AS. The length of the self scan period SS may be the same as the length of the address scan period AS.

FIG. 5 is a drawing to illustrate an address scan period according to an embodiment of the disclosure. In describing FIG. 5, reference is made to the pixel PXij of FIG. 2.

At a time point t1a, an emission signal of a turn-off level (high level) may be applied to the emission line EMi, such that the fifth transistor T5 and the sixth transistor T6 are turned off, and the pixel PXij is in a non-emitting state.

At time t2a, a third scan signal with a turn-on level (high level) may be applied to the third scan line GIi, which turns on the fourth transistor T4. Accordingly, an initialization voltage VINT may be applied to the first node N1. The initialization voltage VINT may be a sufficiently low voltage to make the first transistor T1 on-biased.

At time point t3a, the third transistor T3 may be turned on by applying a fourth scan signal at the turn-on level (high level) to the fourth scan line GCi. Accordingly, the first transistor T1 is in a diode connected state in which the drain electrode and the gate electrode are connected.

At time t4a, the second transistor T2 may be turned on by applying a scan signal of the turn-on level (low level) to the first scan line GWi. Thus, a data voltage of the data line DLj may be applied to the first node N1 through the second transistor T2, the first transistor T1, and the third transistor T3 in the turn-on state. At this time, the voltage of the first node N1 may be a compensation voltage that is a data voltage minus a threshold voltage of the first transistor T1. The storage capacitor Cst may maintain a difference between the second power supply voltage ELVDD and the compensation voltage.

At time point t5a, a scan signal of the turn-on level (low level) may be applied to the second scan line GBi, thereby turning on the seventh transistor T7 and the eighth transistor T8. As the seventh transistor T7 is turned on, an anode initialization voltage VAINT is applied to the anode of the light emitting element LD, and the light emitting element LD may be initialized with a charge amount corresponding to a voltage difference between the anode initialization voltage VAINT and the first power supply voltage ELVSS. Accordingly, the low grayscale expression of the light emitting element LD may be facilitated.

Further, as the eighth transistor T8 is turned on, the voltage of the second node N2 may be set to a bias voltage VOBS. Accordingly, since the bias voltage VOBS is applied to the source electrode of the first transistor T1, a hysteresis phenomenon may be prevented and an on-bias state may be ensured.

At time t6a, the fifth transistor T5 and the sixth transistor T6 may be turned on by applying an emission signal of the turn-on level (low level) to the emission line EMi. Thus, a path of the driving current flowing from the second power supply voltage ELVDD toward the first power supply voltage ELVSS via the fifth transistor T5, the first transistor T1, the sixth transistor T6, and the light emitting element LD is formed.

The amount of driving current may be adjusted according to the voltage maintained on the storage capacitor Cst. The light emitting element LD emits with a luminance corresponding to the amount of driving current. The light emitting element LD may emit until an emission signal of a turn-off level is applied to the emission line EMi.

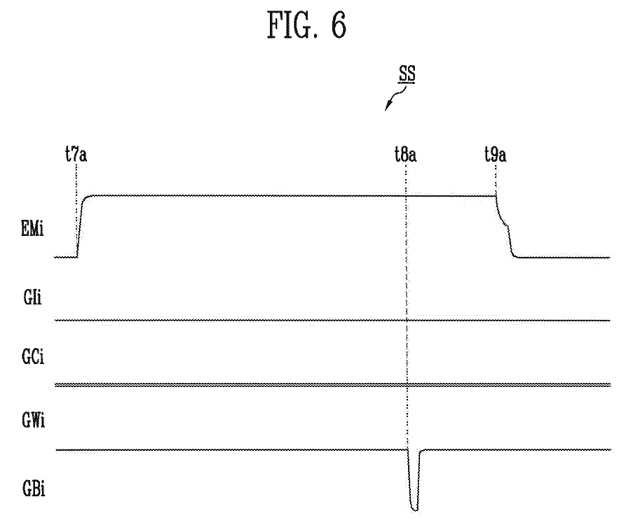

FIG. 6 is a drawing for illustrating a self scan period according to an embodiment of the disclosure. In describing FIG. 6, reference is made to the pixel PXij of FIG. 2.

At time point t7a, a light emission signal of the turn-off level (high-level) is applied to the light emission line EMi, so that the fifth transistor T5 and the sixth transistor T6 are turned off, and the pixel PXij is in a non-emitting state.

During the periods t7a to t8a, the first scan line GWi, the third scan line GIi, and the fourth scan line GCi are maintained at the turn-off level. Therefore, the voltage at the first node N1 remains unchanged.

At time point t8a, a scan signal of the turn-on level (low level) may be applied to the second scan line GBi, thereby turning on the seventh transistor T7 and the eighth transistor T8. As the seventh transistor T7 is turned on, an anode initialization voltage VAINT is applied to the anode of the light emitting element LD, and the light emitting element LD may be initialized with a charge amount corresponding to a voltage difference between the anode initialization voltage VAINT and the first power supply voltage ELVSS. Accordingly, the low grayscale expression of the light emitting element LD may be facilitated.

Further, as the eighth transistor T8 is turned on, the voltage of the second node N2 may be set to a bias voltage VOBS. Accordingly, since the bias voltage VOBS is applied to the source electrode of the first transistor T1, a hysteresis phenomenon may be prevented and an on-bias state may be ensured.

At time t9a, the fifth transistor T5 and the sixth transistor T6 may be turned on by applying an emission signal of the turn-on level (low level) to the emission line EMi. Thus, the path of the driving current flowing from the second power supply voltage ELVDD toward the first power supply voltage ELVSS via the fifth transistor T5, the first transistor T1, the sixth transistor T6, and the light emitting element LD is formed.

Depending on the voltage maintained in the storage capacitor Cst, the amount of driving current may be adjusted. Since the voltage of the first node N1 recorded during the address scan period AS is maintained during the self scan period SS, the luminance of the pixel PXij in the self scan period SS is the same as the luminance of the pixel PXij in the address scan period AS.

FIG. 7 is a drawing to illustrate a voltage setting device according to an embodiment of the disclosure.

Referring to FIG. 7, a voltage setting device ED according to an embodiment of the disclosure may include an optical system 110 and a test control unit 120. The optical system 110 may measure luminance and color coordinate of an image. For example, the optical system 110 may include a camera, a luminance meter, a colorimeter, a spectrometer, a spectrophotometer, or the like. The test control unit 120 may be a computing device. For example, the computing device may include a recording medium and a processor. The recording medium and the processor may be included on the same physical device, but may also be included on physically different devices, such as by utilizing clouding technology.

The recording medium may include any type of recording device that can store data or programs that can be read by a processor. Examples of processor-readable storage media may include ROMs, RAM, CD-ROMs, magnetic tapes, floppy disks, optical data storage devices, hard disks, external hard disks, SSDs, USB storage devices, DVDs, Blu-ray^{TM} disks, and the like. The processor-readable storage medium may also be a combination of multiple devices and may be distributed across a networked computer system. Such a recording medium may be a non-transitory computer readable medium. A non-transitory recording medium may be a medium that stores data or programs on a semi-permanent basis and may be readable by a processor, as opposed to a medium that stores data or programs for a brief moment, such as a register, cache, memory, etc.

The test control unit 120 may provide test voltages to the display device 10' to enable the display device 10' to display an image. The test voltages may include a test initialization voltage and test data voltages. For example, the test initialization voltage may be a voltage that is applied in place of the initialization voltage VINT during the voltage setting process. For example, the test data voltage may be a voltage that is applied in place of the data voltage during the voltage setting process.

The display device 10' may refer to a single display device, or may refer to multiple display devices. The display device 10' may be one of multiple display devices disposed on a mother glass having a large area. For example, the voltage setting process may be performed prior to scribing the mother glass.

The optical system 110 may acquire an image displayed by the display device 10' based on the test voltages, measure the luminance of the image, or measure the color coordinate of the image. The optical system 110 may provide the image, the luminance of the image, the color coordinate of the image, and the like to the test control unit 120.

The test control unit 120 may set the test voltages determined to be suitable for the display device 10' to voltage values of the display device 10'. The set voltage values may be stored in the memory 17 of the display device 10'.

FIG. 8 is a drawing to illustrate a voltage setting method for a display device according to an embodiment of the disclosure.

First, the test control unit 120 may set the first power supply voltage ELVSS of the display device 10' (S101). At this time, the first power supply voltage ELVSS may be set independently for each of the maximum luminances. For example, the driving current required when the maximum luminance is 2175 nits may be greater than the driving current required when the maximum luminance is 1200 nits. For example, the difference between the second power supply voltage ELVDD and the first power supply voltage ELVSS when the maximum luminance is 2175 nits may be greater than the difference between the second power supply voltage ELVDD and the first power supply voltage ELVSS when the maximum luminance is 1200 nits. For example, the larger the maximum luminance, the lower the first power supply voltage ELVSS may be set.

Each of the subsequent steps S102, S103, S104, S105, S106 may likewise be performed independently for each of the maximum luminances and will not be described herein.

Next, the test control unit 120 may set a black data voltage of the display device 10' (S102). As described above, the black data voltage may be a data voltage written to the pixel when the pixel displays a black image. For example, the black data voltage may correspond to a minimum grayscale (e.g., zero grayscale). For example, the test control unit 120 may incrementally increase temporary black data voltage to check whether the luminance of the black image is below a threshold. When the luminance of the black image falls below the threshold, the test control unit 120 may determine the corresponding temporary black data voltage as the black data voltage. Since the luminance measurement time of the optical system 110 decreases as the brightness of the displayed image increases, it is advantageous to test the temporary black data voltage by gradually increasing it from a minimum value to a maximum value. The black data voltages may be set differently or the same as each color.

Next, the test control unit 120 may set a difference value between the anode initialization voltage VAINT and the first power supply voltage ELVSS of the address scan period AS (S103). Since the voltage value of the first power supply voltage ELVSS has been set in the step (S101), the magnitude of the anode initialization voltage VAINT may be determined through this step (S103).

The smaller the difference value between the anode initialization voltage VAINT and the first power supply voltage ELVSS, the easier it is to achieve low grayscale representation. For example, black jitter can be reduced. On the other hand, a larger difference value has the advantage of increasing the response speed of the pixel PXij and reducing temperature sensitivity.

For example, the test control unit 120 may decrease a temporary difference value incrementally to check whether the luminance of the black image falls below the threshold. When the luminance of the black image falls below the reference value, the test control unit 120 may determine the corresponding temporary difference value as a difference value between the initialization voltage VAINT and the first power supply voltage ELVSS. Since the luminance measurement time of the optical system 110 decreases as the brightness of the displayed image increases, it is advantageous to test the temporary difference value by gradually decreasing it from a maximum value to a minimum value.

As described above, the anode initialization voltage VAINT may be set differently for each of the first to third colors. In another example, the anode initialization voltage VAINT may be set the same for two colors and different for the remaining color.

Next, the test control unit 120 may set an initialization voltage VINT (S104). This step S104 will be described in more detail with reference to the embodiments of FIGS. 9-11. In an embodiment, according to the step (S104), in addition to the initialization voltage VINT, a white data voltage corresponding to a white grayscale (e.g., highest grayscale) may be set. The white data voltages may be set differently or identically for each color.

Next, the test control unit 120 may set the data voltages (S105). At this time, the data voltages of each color may be determined in a corresponding data voltage range. For example, the first pixels emitting in a first color may have data voltages determined in a first data voltage range. The second pixels emitting a second color may have data voltages determined in a second data voltage range. The third pixels emitting the third color may have data voltages determined in the third data voltage range. The minimum values (minimum data voltages) and maximum values (maximum data voltages) of the first to third data voltage ranges may be different or the same. For example, the first to third data voltage ranges may be limited by the relationship between each light emitting element LD and the driving transistor.

The data voltages may be set to be greater than or substantially equal to the test data voltages corresponding to the target luminance (e.g., white luminance), target color coordinate (e.g., white color coordinate), and final test initialization voltage (VINT) set in the previous step (S104). These test data voltages may be set as white data voltages. For example, the data voltages of each color may be set to be greater than or substantially equal to the white data voltages determined in step S104. Also, the data voltages of each color may be set to be less than or substantially equal to the black data voltages determined in step S102.

Next, the test control unit 120 may set a bias voltage VOBS of the self scan period SS (S106). As described in FIGS. 3-6, due to the difference in the driving method of the address scan period AS and the self scan period SS, a flicker phenomenon may appear. In step S106, a bias voltage VOBS may be set to minimize the flicker phenomenon by repeatedly setting and checking the bias voltage VOBS.

Next, the test control unit 120 may set a difference value between the anode initialization voltage VAINT and the first power supply voltage ELVSS of the self scan period SS at step S107. In other words, by setting the difference value in this step S107 independently of the difference value set in the step S103, a luminance difference, a color coordinate difference, etc. due to a change in the display frequency can be minimized.

FIG. 9 is a drawing for illustrating a step of setting an initialization voltage according to an embodiment of the disclosure.

First, the test control unit 120 may select the lowest minimum data voltage of the minimum data voltages of the first to third data voltage ranges as the fixed test data voltage (S1041a). For example, if the minimum data voltage of the first data voltage range for the first color is 0.7 V, the minimum data voltage of the second data voltage range for the second color is 0.6 V, and the minimum data voltage of the third data voltage range for the third color is 0.5 V, the test control unit 120 may select 0.5 V of the third color as the fixed test data voltage.

Next, the test control unit 120 may vary the test initialization voltage and the test data voltages of the pixels of the remaining colors (e.g., the first and second colors), except for the color corresponding to the fixed test data voltage (e.g., the third color), to find a final test initialization voltage corresponding to the target luminance and target color coordinate, and set the final test initialization voltage as the initialization voltage VINT (S1042a, S1043a).

For example, the test control unit 120 may vary the test initialization voltage and the test data voltages of the pixels of the remaining colors to search voltage sets corresponding to a target luminance and a target color coordinate (S1042a). Here, the target luminance may be a white luminance, and the target color coordinate may be a white color coordinate. For example, the test data voltage for the third color may be set as a fixed variable, and the test data voltages for the first and second colors and the test initialization voltage may be set as input variables to search voltage sets corresponding to the target luminance and the target color coordinate. Each of the voltage sets may include test data voltages for the first to third colors and a test initialization voltage. The test data voltages for the third color of each voltage set may be the same (fixed test data voltage).

Next, the test control unit 120 may set the test initialization voltage of the voltage set having the largest test initialization voltage among the searched voltage sets as the final test initialization voltage (S1043a). As described above, the final test initialization voltage may be set as an initialization voltage VINT. In an embodiment, the test data voltages and the fixed test data voltage of the selected voltage sets may be set to white data voltages.

A lower initialization voltage VINT is advantageous for implementing high luminance, and a higher initialization voltage is advantageous for improving the afterimage phenomenon. According to the embodiment, a maximized initialization voltage VINT can reduce the afterimage phenomenon of the display device 10' while implementing high luminance.

According to an embodiment of the disclosure, there is provided a voltage setting method that sets (or determines) an initialization voltage in a display device by applying voltage sets (or combinations of test data voltages and test initialization voltages) to pixels and checking whether a resulting luminance and a resulting color coordinate displayed by the pixels in the display device falls in a target range. A goal is to set the initialization voltage as high as possible for the target ranges of color coordinates and luminance to reduce afterimage. In the embodiment of FIG. 9, data voltages are varied for only two out of three colors displayed on the display device. As a largest initialization voltage having luminance and color coordinates in the target range is selected and set as the initialization voltage for the display device so that afterimage can be minimized.

FIG. 10 is a drawing to illustrate steps for setting an initialization voltage according to an embodiment of the disclosure.

First, the test control unit 120 may select the lowest minimum data voltage of the minimum data voltages of the first to third data voltage ranges as the fixed test data voltage (S1041b). For example, if the minimum data voltage of the first data voltage range for the first color is 0.7 V, the minimum data voltage of the second data voltage range for the second color is 0.6 V, and the minimum data voltage of the third data voltage range for the third color is 0.5 V, the test control unit 120 may select 0.5 V of the third color as the fixed test data voltage.

Next, the test control unit 120 varies a test initialization voltage and the test data voltages of the pixels of the remaining colors (e.g., the first color and the second color), except for the color corresponding to the fixed test data voltage (e.g., the third color), to find a final test initialization voltage corresponding to the target luminance and target color coordinate, and may set the final test initialization voltage as the initialization voltage VINT (S1042b, S1043b, S1044b, S1045b, S1046b, S1047b, S1048b).

For example, the test control unit 120 may set an initial test initialization voltage and change the test data voltages of the pixels of the remaining colors (S1042b). For example, the test control unit 120 may set the initial test initialization voltage to -4 V. Further, the test control unit 120 may change the test data voltages of the pixels of the first color and the second color. At this time, the test control unit 120 may calculate test data voltages that are expected to achieve a target luminance (white luminance) and a target color coordinate (white color coordinate) based on the fixed test data voltage (e.g., 0.5 V) and the initial test initialization voltage (e.g., (-)4 V).

Based on the fixed test data voltage, the initial test initialization voltage, and the test data voltages calculated in step S1042b, the display device 10' may display an image. The optical system 110 may provide the current luminance and current color coordinate of these images to the test control unit 120. Accordingly, the test control unit 120 may check whether the current luminance and the current color coordinate fall in a target range (S1043b).

If the current luminance and the current color coordinate are not in the target range, the test control unit 120 may again perform the step S1042b of changing the test data voltages of the pixels of the remaining colors. At this time, the initial test initialization voltage and the fixed test data voltage may be maintained. The target range may include a luminance range corresponding to a target luminance and a color coordinate range corresponding to a target color coordinate.

If the current luminance and current color coordinate fall in the target range, the test control unit 120 may check whether the test data voltages of the pixels of the remaining colors fall in the corresponding data voltage ranges (S1044b). For example, if the remaining colors are a first color and a second color, the corresponding data voltage ranges may be a first data voltage range and a second data voltage range.

If the test data voltages of the pixels of the remaining colors fall in the corresponding data voltage ranges, the test control unit 120 may set the current test initialization voltage as the final test initialization voltage (S1047b). In an embodiment, the test data voltages and the fixed test data voltage corresponding to the final test initialization voltage may be set to white data voltages.

However, if the test data voltages of the pixels of the remaining colors do not fall in the corresponding data voltage ranges, the test control unit 120 may decrease the current test initialization voltage (S1045b). For example, the test control unit 120 may decrease the current test initialization voltage by 0.5 volts.

The test control unit 120 may check whether the current test initialization voltage is greater than a minimum initialization voltage (S1046b). For example, the minimum initialization voltage may be -6 volts.

The test control unit 120 may perform the step S1042b of changing the test data voltages of the pixels of the remaining colors again if the current test initialization voltage is greater than the minimum initialization voltage.

If the current test initialization voltage is less than the minimum initialization voltage, the test control unit 120 may determine the display device 10' to be defective (S1048b).

According to the embodiment, by confirming that the test data voltages fall in the corresponding data voltage ranges in step S1044b, the margin of the data voltage of the display device 10' can be satisfied. Further, by setting the initialization voltage VINT of the display device 10' to be as high as possible, it becomes advantageous to reduce the afterimage.

According to the embodiment of FIG. 10, there is provided a voltage setting method that sets (or determines) an initialization voltage in a display device by applying voltage sets (or combinations of test data voltages and test initialization voltages) to pixels and checking whether a resulting luminance and a resulting color coordinate displayed by the pixels in the display device falls in a target range. The method of FIG. 10 reduces afterimage while ensuring that the test data voltages used are in data voltage ranges. The method of FIG. 10 also varies data voltages of only two out of three colors displayed on the display device. Unlike the method of FIG. 9, the test initialization voltage starts at a high level and decrements throughout the method until color coordinate and luminance fall in a target range, upon which the initialization voltage is set. This ensures that the highest possible initialization voltage is used to minimize afterimage.

FIG. 11 is a drawing to illustrate a step of setting an initialization voltage according to an embodiment of the disclosure.

First, the test control unit 120 may set an initial test initialization voltage (S1041c). For example, the test control unit 120 may set the initial test initialization voltage to -4 volts.

Next, the test control unit 120 may change the test data voltages of the first, second, and third pixels and the initial test initialization voltage to find a final test initialization voltage corresponding to the target luminance and the target color coordinate, and set the final test initialization voltage as the initialization voltage VINT (S1042c, S1043c, S1044c, S1045c, S1046c, S1047c, S1048c). The final test initialization voltage may be lower than or substantially equal to the initial test initialization voltage. In this embodiment, there is no fixed test data voltage.

For example, the test control unit 120 may change the test data voltages of the pixels of the first to third colors (S1042c). At this time, the test control unit 120 may calculate test data voltages that are expected to achieve a target luminance (white luminance) and a target color coordinate (white color coordinate) based on an initial test initialization voltage (e.g., -4 V).

Based on the initial test initialization voltage and the test data voltages calculated in step S1042c, the display device 10' may display an image. The optical system 110 may provide the current luminance and current color coordinate of these images to the test control unit 120. Accordingly, the test control unit 120 may check whether the current luminance and the current color coordinate fall in a target range (S1043c).

The test control unit 120 may again perform step S1042c of changing the test data voltages if the current luminance and current color coordinate are not in the target range. At this time, the initial test initialization voltage may be maintained. The target range may include a luminance range corresponding to a target luminance and a color coordinate range corresponding to a target color coordinate.

If the current luminance and current color coordinate fall in the target range, the test control unit 120 may check whether the test data voltages of the pixels fall in corresponding data voltage ranges (S1044c). For example, the corresponding data voltage ranges may be a first data voltage range, a second data voltage range, and a third data voltage range.

If the test data voltages fall in the corresponding data voltage ranges, the test control unit 120 may set the current test initialization voltage as the final test initialization voltage (S1047c). In an embodiment, the test data voltages corresponding to the final test initialization voltage may be set to white data voltages.

However, if the test data voltages do not fall in the corresponding data voltage ranges, the test control unit 120 may decrease the current test initialization voltage (S1045c). For example, the test control unit 120 may decrease the current test initialization voltage by 0.5 volts.

The test control unit 120 may check whether the current test initialization voltage is greater than a minimum initialization voltage (S1046c). For example, the minimum initialization voltage may be -6 volts.

If the current test initialization voltage is greater than the minimum initialization voltage, the test control unit 120 may again perform the step S1042c of changing the test data voltages of the pixels of the remaining colors.

If the current test initialization voltage is less than the minimum initialization voltage, the test control unit 120 may determine the display device 10' to be defective (S1048c).

According to the embodiment, by confirming that the test data voltages fall in the corresponding data voltage ranges in step S1044c, the margin of the data voltage of the display device 10' may be satisfied. Furthermore, by setting the initialization voltage VINT of the display device 10' to be as high as possible, it becomes advantageous to minimize the afterimage.

According to the embodiment of FIG. 11, there is provided a voltage setting method that sets (or determines) an initialization voltage in a display device by applying voltage sets (or combinations of test data voltages and test initialization voltages) to pixels and checking whether a resulting luminance and a resulting color coordinate displayed by the pixels in the display device falls in a target range. The method of FIG. 11 reduces afterimage while ensuring that the test data voltages used are in data voltage ranges. Unlike the method of FIGS. 9 and 10, the method of FIG. 11 varies data voltages for all three colors displayed on the display device. Like the method of FIG. 10, the test initialization voltage starts at a high level and decrements throughout the method until color coordinate and luminance fall in a target range, upon which the initialization voltage is set. This ensures that the highest possible initialization voltage is used to minimize afterimage.

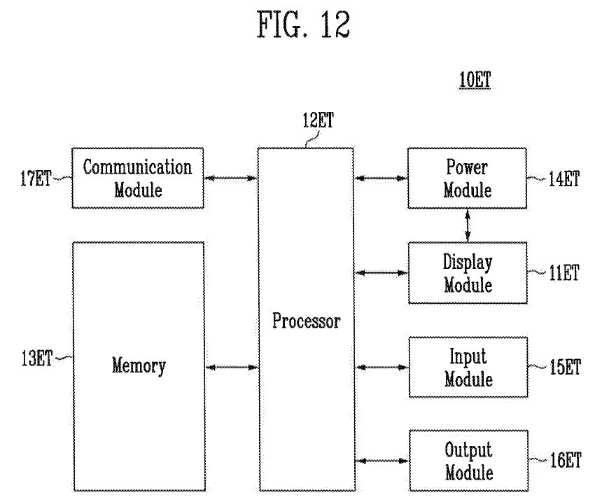

FIG. 12 is a block diagram of an electronic device according to an embodiment. Referring to FIG. 12, the electronic device 10ET according to an embodiment may include a display module 11ET, a processor 12ET, a memory 13ET, and a power module 14ET. The display module 11ET may also be represented by a display device.

The processor 12ET may include at least one of a central processing unit (CPU), an application processor (AP), a graphic processing unit (GPU), a communication processor (CP), an image signal processor (ISP), and a controller. In an embodiment, the processor 12ET may be partitioned into two or more processors from a functional or structural perspective. For example, the processor 12ET may include a main processor in the form of a first drive chip that includes a central processing unit, and a second processor in the form of a second drive chip that includes a controller that receives image signals from the main processor and processes the image signals to meet the interface specifications of the display module 11ET. The processor 12ET may provide image data. The display module 11ET may display an image based on grayscales of the image data.

The memory 13ET may include at least one of non-volatile memory and volatile memory. The memory 13ET may store data information necessary for operation of the processor 12ET or the display module 11ET. When the processor 12ET executes an application stored in the memory 13ET, image data signals and/or input control signals may be delivered to the display module 11ET, and the display module 11ET may process the received signals to output image information via the display screen.

The power module 14ET can include a power supply module, such as a power adapter or battery unit, and a power conversion module that converts the power supplied by the power supply module to generate the power required for operation of the electronic device 10ET. The power conversion by the power conversion module may include, but is not limited to, DC-DC conversion, AC-DC conversion, and DC-AC conversion.

The electronic device 10ET may further include an input module 15ET, a non-image output module 16ET, and/or a communication module 17ET.

The input module 15ET can provide input information to the processor 12ET and/or the display module 11ET. The input module 15ET can include physical buttons, a keyboard, a microphone, as well as various sensor modules. Examples of sensor modules may include touch sensors, pressure sensors, distance sensors, position sensors, digitizers, motion recognition sensors, camera sensors, light sensors, photoelectric sensors, temperature sensors, as well as biosensors such as blood pressure sensors, blood glucose sensors, electrocardiogram sensors, heart rate sensors, and the like.

The non-image output module 16ET may serve to receive information other than images received from the processor 12ET and provide it to a user. Examples of the non-image output module 16ET may include an acoustic module, a haptic module, a light emitting module, and other functional modules unique to an electronic device (e.g., a cooling module in a refrigerator, etc.).

The communication module 17ET is a module responsible for sending and receiving information between the electronic device 10ET and an external device, and may include a receiving part and a transmitting part. The communication module 17ET may include various wireless communication modules, such as a mobile communication module, a Wi-Fi module, a Bluetooth^{TM} module, or various wired communication modules.

At least one of each of the above-described configurations of the electronic device 10ET may be included in the display device according to the above-described embodiments. Furthermore, some of the individual modules that are functionally contained in a module may be included in the display device and others may be provided separately from the display device. For example, the display device may include a display module 11ET, while the processor 12ET, memory 13ET, and power module 14ET may be provided in the form of other devices in the electronic device 10ET other than the display device. As another example, the power module 14ET may be provided in the display device and power the processor 12ET and memory 13ET may be provided in the electronic device 10ET external to the display device, without limiting the above examples.

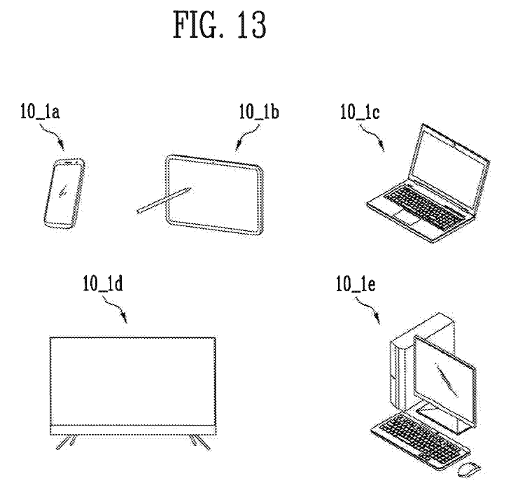

FIGS. 13-15 are schematic diagrams of electronic devices according to various embodiments. FIGS. 13-15 illustrate examples of various electronic devices with display devices according to various embodiments.

FIG. 13 illustrates a smartphone 10_1a, a tablet 10_1b, a laptop 10_1c, a TV 10_1d, and a monitor 10_1e as examples of electronic devices.

In addition to the display module 11ET, the smartphone 10_1a may include an input module, such as a touch sensor, and a communication module. The smartphone 10_1a may process information received via the communication module or other input module and display the information via the display module of the display device.

Similar to the smartphone 10_1a, tablet 10_1b, laptops 10_1c, TVs 10_1d, and desk 10_1e may also include a display module and an input module, and in some cases may further include a communication module.

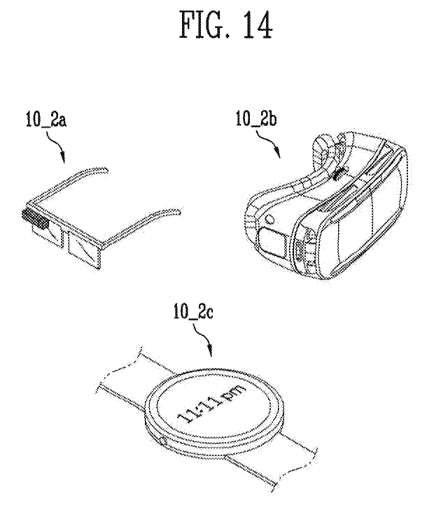

FIG. 14 illustrates an example where an electronic device including a display module is applied to a wearable electronic device. The wearable electronic device may be a smart eyewear 10_2a, a head-mounted display 10_2b, a smart watch 10_2c, or the like.

The smart glasses 10_2a and the head-mounted display 10_2b may include a display module for projecting a display image and a reflector for reflecting the projected display image and providing it to the user's eyes, thereby providing the user with a view of virtual reality or augmented reality.

The smartwatch 10_2c may include a biometric sensor as an input device, and may provide biometric information recognized through the biometric sensor to the user via the display module.

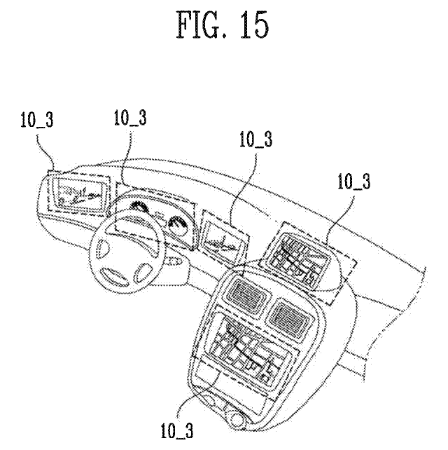

FIG. 15 illustrates an example of an electronic device including a display module applied to a vehicle. For example, the electronic device 10_3 may be applied to the instrument panel, center fascia, etc. of a vehicle, or to a Center Information Display (CID) placed on the dashboard of a vehicle, or to a room mirror display that replaces a side mirror.

Although not shown, electronic devices with display modules according to embodiments may include not only devices that focus on displaying screens, such as billboards, billboards, and gaming machines, but also various household appliances that display information via display modules, such as refrigerators, washers, dryers, air conditioners, robotic vacuum cleaners, and the like. Furthermore, if the display module has a function of transmitting light, it may be applied to electronic devices such as smart windows or transparent display devices that display a background and a display image together. The types of electronic devices according to the embodiments are not limited by the above examples, and it is possible to apply various other electronic devices not shown.

The foregoing referenced drawings and detailed description of the disclosure are merely exemplary of the disclosure and are used for the purpose of illustrating the disclosure and are not intended to be limiting in meaning or to limit the scope of the disclosure as claimed in the appended patent claims. One having ordinary skill in the art will therefore understand that many variations and embodiments are possible therefrom.

What is claimed is:

1. A voltage setting method of a display device comprising:
providing a plurality of pixels comprising:
a plurality of first pixels emitting a first color in response to a data voltage in a first data voltage range;
a plurality of second pixels emitting a second color in response to a data voltage in a second data voltage range; and
a plurality of third pixels emitting a third color in response to a data voltage in a third data voltage range;
setting an initialization voltage commonly applied to gate electrodes of driving transistors included in the plurality of pixels, wherein the setting the initialization voltage comprises:
selecting lowest minimum data voltage of minimum data voltages of the first to third data voltage ranges as a fixed test data voltage;
varying test data voltages and test initialization voltages of ones of the plurality of pixels of remaining colors other than a color corresponding to the fixed test data voltage to find a final test initialization voltage corresponding to a target luminance and a target color coordinate; and
setting the final test initialization voltage as the initialization voltage.

2. The method of claim 1, further comprising:
setting data voltages of the plurality of pixels, wherein
the data voltages are set to be greater than or substantially equal to test data voltages corresponding to the target luminance, the target color coordinate, and the final test initialization voltage.

3. The method of claim 1, wherein the setting of the final test initialization voltage as the initialization voltage comprises:
varying the test initialization voltage and the test data voltages of ones of the plurality of pixels of the remaining colors to search voltage sets corresponding to the target luminance and the target color coordinate; and
setting a test initialization voltage of a voltage set having largest test initialization voltage among the voltage sets searched as the final test initialization voltage.

4. The method of claim 1, wherein the setting of the final test initialization voltage as the initialization voltage comprises:
setting an initial test initialization voltage and varying test data voltages of ones of the plurality of pixels of the remaining colors;
checking whether current luminance and current color coordinate fall in a target range; and
performing again the varying of the test data voltages of the ones of the plurality of pixels of the remaining colors if the current luminance and the current color coordinate do not fall in the target range.

5. The method of claim 4, wherein the setting of the final test initialization voltage as the initialization voltage further comprises:
checking whether test data voltages of ones of the plurality of pixels of the remaining colors fall in corresponding data voltage ranges if the current luminance and the current color coordinate fall in the target range; and
setting a current test initialization voltage as the final test initialization voltage if the test data voltages of the plurality of pixels of the remaining colors fall in corresponding data voltage ranges.

6. The method of claim 5, wherein the of setting the final test initialization voltage as the initialization voltage further comprises:
decreasing the current test initialization voltage if the test data voltages of ones of the plurality of pixels of the remaining colors do not fall in corresponding data voltage ranges.

7. The method of claim 6, wherein of the setting the final test initialization voltage as the initialization voltage further comprises:
checking if the current test initialization voltage is greater than a minimum initialization voltage, and
performing the varying of the test data voltages of ones of the plurality of pixels of the remaining colors again if the current test initialization voltage is greater than the minimum initialization voltage.

8. The method of claim 7, wherein the setting the final test initialization voltage as the initialization voltage further comprises:
determining the display device to be defective if the current test initialization voltage is less than the minimum initialization voltage.

9. A voltage setting method of a display device comprising:
providing a plurality of pixels comprising:
a plurality of first pixels emitting a first color in response to a data voltage in a first data voltage range;
a plurality of second pixels emitting a second color in response to a data voltage in a second data voltage range;, and
a plurality of third pixels emitting a third color in response to a data voltage in a third data voltage range
setting an initialization voltage commonly applied to gate electrodes of driving transistors included in the plurality of pixels, wherein the setting of the initialization voltage comprises:
setting an initial test initialization voltage; and
varying test data voltages of the plurality of pixels and the initial test initialization voltage to find a final test initialization voltage corresponding to a target luminance and a target color coordinate; and
setting the final test initialization voltage as the initialization voltage, wherein
the final test initialization voltage being less than or substantially equal to the initial test initialization voltage.

10. The method of claim 9, wherein the setting of the final test initialization voltage as the initialization voltage comprises:
varying test data voltages of the plurality of pixels;
checking whether a current luminance and a current color coordinate fall in a target range; and
performing the varying of the test data voltages again if the current luminance and the current color coordinate do not fall in the target range.

11. The method of claim 10, wherein the setting of the final test initialization voltage as the initialization voltage further comprises:
checking whether test data voltages of the plurality of pixels fall in corresponding data voltage ranges if the current luminance and the current color coordinate fall in the target range; and
setting a current test initialization voltage as the final test initialization voltage if the test data voltages fall in the corresponding data voltage ranges.

12. The method of claim 11, wherein the setting of the final test initialization voltage as the initialization voltage further comprises:
decreasing the current test initialization voltage if the test data voltages do not fall in corresponding data voltage ranges.

13. The method of claim 12, wherein the setting of the final test initialization voltage as the initialization voltage further comprises:
checking whether the current test initialization voltage is greater than a minimum initialization voltage; and
performing the varying of the test data voltages again if the current test initialization voltage is greater than the minimum initialization voltage.

14. The method of claim 13, wherein the setting of the final test initialization voltage as the initialization voltage further comprises:
determining the display device to be defective if the current test initialization voltage is less than the minimum initialization voltage.

15. An electronic device comprising:
a display device comprising a plurality of pixels comprising:
a plurality of first pixels emitting light of a first color in response to a data voltage in a first data voltage range;
a plurality of second pixels emitting a second color in response to a data voltage in a second data voltage range; and
a plurality of third pixels emitting a third color in response to a data voltage in a third data voltage range;
a voltage setting device configured to set a voltage of the display device, the voltage setting device comprising:
a test control unit configured to provide test voltages to the display device to enable the display device to display an image; and
an optical system configured to measure luminance and color coordinate of the image, wherein
the test voltages include a test initialization voltage and test data voltages,
the initialization voltage is a voltage commonly applied to gate electrodes of driving transistors included in the plurality of pixels,
the test control unit is further configured to:
select a lowest minimum data voltage of minimum data voltages of the first to third data voltage ranges as a fixed test data voltage, and
vary the test initialization voltage and the test data voltages of the plurality of pixels of remaining colors other than a color corresponding to the fixed test data voltages to find a final test initialization voltage corresponding to a target luminance and a target color coordinate, and
set the final test initialization voltage as the initialization voltage.

16. The electronic device of claim 15, wherein
the test control unit is further configured to set the data voltages of the plurality of pixels, and
the data voltages are set to be greater than or substantially equal to test data voltages corresponding to the target luminance, the target color coordinate, and the final test initialization voltage.

17. The electronic device of claim 15, wherein the test control unit is further configured to:
search voltage sets corresponding to the target luminance and the target color coordinate by varying the test initialization voltage and the test data voltages of the plurality of pixels of the remaining colors, and
set a test initialization voltage of a voltage set having largest test initialization voltage among the voltage sets searched as the final test initialization voltage.

18. The electronic device of claim 15, wherein the test control unit is further configured to
set an initial test initialization voltage and vary test data voltages of the plurality of pixels of the remaining colors,
check whether a current luminance and a current color coordinate fall in a target range, and
vary test data voltages of the plurality of pixels of the remaining colors again if the current luminance and the current color coordinate do not fall in the target range.

19. The electronic device of claim 18, wherein the test control unit is further configured to:
check whether test data voltages of the plurality of pixels of the remaining colors fall in corresponding data voltage ranges if the current luminance and the current color coordinate fall in the target range, and
set a current test initialization voltage as the final test initialization voltage if the test data voltages of the plurality of pixels of the remaining colors fall in corresponding data voltage ranges.

20. The electronic device of claim 19, wherein the test control unit is further configured to decrease the current test initialization voltage if the test data voltages of the plurality of pixels of the remaining colors do not fall in the corresponding data voltage ranges.
